(19) United States
(12) Patent Application Publication
(10) Pub. No.: US 2008/0248950 A1
(43) Pub. Date: Oct. 9, 2008

(54) Ink and Developer System

(76) Inventors: Ibrahim Katampe, Kettering, OH (US); Gerard Ross, Centerville, OH (US)

Correspondence Address: THOMPSON HINE L.L.P.;Intellectual Property Group, P.O. BOX 8801, DAYTON, OH, 45401-8801, US

(21) Appl. No.: 11/866,666

(22) Filed: Oct. 3, 2007

Related U.S. Application Data
(60) Provisional application No. 60/921,752, filed on Apr. 4, 2007.

(51) Int. Cl. B41M 5/00

(52) U.S. Cl. 503/213

(57) ABSTRACT

An ink and developer system including an ink component including a non-synthetic oil-based carrier and a chromogenic material dispersed or dissolved in the non-synthetic oil-based carrier, and a substrate including a developer composition capable of initiating a color change in the chromogenic material.

The present application claims priority from U.S. Ser. No. 60/921,752 filed on Apr. 4, 2007, the entire contents of which are incorporated herein by reference.

### BACKGROUND

The present application relates generally to systems for marking, painting or coloring materials and, more particularly, to marking, painting or coloring systems that prevent stray marks, paints or colors from appearing on surfaces upon which they are inadvertently placed.

Artwork is commonly used as a developmental tool for children. For example, marking inks and paints are particularly useful because they can stimulate thought and creativity when used. However, conventional marking and painting materials have a significant drawback in that they can be messy. This messiness is exacerbated by the fact that the stains are typically extremely difficult to remove by most conventional methods of cleaning. Parents may prevent, limit or restrict the use of some inks and paints to avoid staining clothing, skin or household objects such as furniture, carpeting and walls.

Thus, many products have been marketed that purport to be washable by conventional means or that have inks or dyes that do not stain skin, clothing and household goods. However, such products do not always succeed in their intended purpose, commonly leaving stains that are still present after washing.

Accordingly, there is a need for writing, painting and coloring instruments that reduce or eliminate staining, but at the same time do not hinder their use as developmental tools for children.

### SUMMARY

In one aspect, the disclosed ink and developer system may include an ink component including a non-synthetic oil-based carrier and a chromogenic material dispersed or dissolved in the non-synthetic oil-based carrier, and a substrate including a developer composition capable of initiating a color change in the chromogenic material.

In another aspect, the disclosed ink and developer system may include an ink component including a plant-derived oil carrier and a leuco dye dispersed or dissolved in the plant-derived oil carrier, and a substrate including an acid resin capable of initiating a color change in the leuco dye.

In another aspect, the disclosed ink and developer system may provide a method for creating a colored marking. The method may includes the steps of providing a substrate including a developer composition, applying an ink composition onto the substrate, the ink composition including a non-synthetic oil-based carrier and a chromogenic material dispersed or dissolved in the non-synthetic oil-based carrier, wherein the chromogenic material undergoes a color change upon contact with the developer composition.

Other aspects of the disclosed ink and developer system will become apparent from the following description, the accompanying drawings and the appended claims.

### BRIEF DESCRIPTION OF THE DRAWINGS

FIG. 1 is a cross-sectional view of a substrate according to one aspect of the disclosed ink and developer system.

### DETAILED DESCRIPTION

In one aspect, the disclosed ink and developer system may include an ink component and a substrate onto which the ink component may be applied. The ink component may be colorless prior to contact with the substrate. The substrate may be coated with, or otherwise include, a developer composition that reacts with the ink component, thereby rendering the colorless ink component colored. Therefore, the disclosed ink and developer system only provides a colored marking or image when the ink component is applied to an appropriate substrate.

The substrate may be formed from or may include any suitable substrate material and may define a surface onto which a user may deposit the ink component of the disclosed ink and developer system. Those skilled in the art will appreciate that the substrate may be a generally planar sheet of material, a three-dimensional object or any other appropriate substrate.

In one aspect, the substrate may be a paper-based or cellulose-based material. Non-limiting examples of useful paper-based or cellulose-based substrates include paper, paperboard, synthetic paper (e.g., polyolefin or polystyrene-based paper), fine paper, art paper, coated paper, cast coated paper, wall paper, backing paper, synthetic resin intercalated paper, paperboard and cellulose fiber paper.

In another aspect, the substrate may be an opaque, transparent or translucent polymeric material. Non-limiting examples of useful polymeric substrates include films or sheets formed from or including polyolefin, polyvinyl chloride, polyethylene terephthalate, polystyrene, polymethacrylate, polycarbonate and synthetic resin. Optionally, the films and sheets may include various pigments (e.g., white pigments) and/or fillers.

Additional examples of useful substrates include various woven and non-woven fabrics, non-porous surfaces, such as glass, ceramics and tiles, and school or office products, such as notebooks, binders, decals, labels, personalized transfers, stick-ons, overhead projector transparencies and the like.

Those skilled in the art will appreciate that the substrate may be formed from multiple sheets or layers of various like or unlike materials that have been laminated together in any desired combination. Examples of appropriate laminates include combined cellulose fiber paper/synthetic paper and combined cellulose fiber paper/plastic films or sheets.

The substrate may incorporate, be coated with, or otherwise include a developer composition that renders the colorless ink component of the disclosed system colored. In one aspect, the developer composition may render the colorless ink component colored generally instantly or rapidly upon contact. In another aspect, the developer composition may render the colorless ink component colored over a period of time.

The developer composition may include one or more active components, such as acid resins or other acidic materials, that facilitate the color change of the ink component. Furthermore, in addition to the active components, the developer composition may optionally include various inactive components, such as carriers, binders, solvents and the like. For example, a developer composition may be formed by dispersing an acid resin in a carrier, such as water, or dissolving an acid resin in an organic solvent, such as acetone.

Examples of appropriate active components of the developer composition may include clay minerals, such as acid clay, active clay or attapulgite, organic acids, such as tannic acid, gallic acid or propyl gallate, acid polymers or resins, such as phenol-formaldehyde resins, phenol acetylene condensation resins or condensates between an organic carboxylic acid having at least one hydroxy group and formaldehyde. The active components of the developer composition may also be formed from or may include metal salts or aromatic carboxylic acids or derivatives thereof such as zinc salicylate, tin salicylate, zinc 2-hydroxy napththoate, zinc 3,5 di-tert butyl salicylate, zinc 3,5-di-(.alpha.-methylbenzyl) salicylate, oil soluble metals, salts, or phenol-formaldehyde novolak resins (e.g., see U.S. Pat. Nos. 3,672,935 and 3,732,120) such as zinc modified oil soluble phenol-formaldehyde resin as disclosed in U.S. Pat. No. 3,732,120, zinc carbonate etc. and mixtures thereof.

In one aspect, the developer composition may include active components having a particle size ranging from about 0.2 microns to about 3 microns in size or about 0.5 microns to about 1.5 microns in size. Those skilled in the art will appreciate that the particle size of the active components of the developer composition may be selected to optimize the chemical interaction between the ink component and the substrate component of the disclosed ink and developer system.

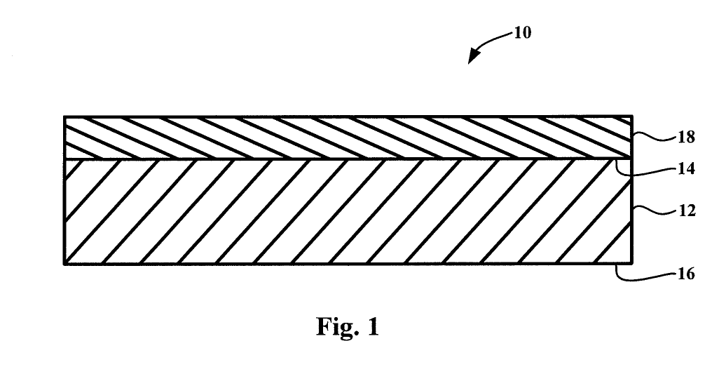

Referring to FIG. 1, an exemplary substrate, generally designated 10, may include a base material 12 having a first surface 14 and a second surface 16, and a developer composition layer 18 applied to the first surface 14 of the base material 12. The developer composition layer 18 may include a developer composition, as described above, and may be applied to the base material 12 by various means, such as, for example, spray coating, curtain coating, dipping, brushing, rollers and the like.

The ink component of the disclosed system may include a carrier composition and a chromogenic material. The chromogenic material may be dissolved and/or dispersed in the carrier composition. Optionally, the ink component may include various additional components, such as stability agents, viscosity modifying agents, biocides and the like.

The ink component may be stored in a vessel, such as a tube, a container or the like, and may be dispensed onto the substrate using any available technique or vehicle, such as a marker, a pencil, a crayon, a stamp, a pen, a paintbrush, a spray, a user's fingers or the like. The viscosity of the ink component may be selected based upon the intended use of the ink component. For example, the ink component may have a high viscosity when the ink component is intended to be used as a paint or a low viscosity when the ink component is intended to be used in a pen or marker (e.g., a felt-tipped marker).

In one aspect, the carrier composition may be formed from or may include non-synthetic oils, such as oils derived from plants. Examples of plant-derived oils useful as the carrier composition include vegetable oil, canola oil, corn oil, soya oil, sunflower seed oil, peanut oil, olive oil and the like. In one aspect, such plant-derived oils may be food grade and, therefore, non-toxic and safe for use by young children.

In another aspect, the carrier composition may include one or more oils conventionally used in carbonless paper manufacture. In particular, the carrier composition may include an oil having the ability to dissolve crystal violet lactone in a concentration of at least about 0.5 percent by weight. Examples of appropriate oils include oils that contain alkylated biphenyls (e.g., monoisopropylbiphenyl), polychlorinated biphenyls, caster oil, mineral oil, deodorized kerosene, naphthenic mineral oils, dibutyl phthalate, dibutyl fumarate, brominated paraffin and combinations and mixtures thereof.

In another aspect, the carrier composition may be formed from or may include a soft wax, such as a natural wax or a synthetic wax and may be crystalline, non-crystalline or semi-crystalline in nature. Examples of appropriate soft wax components include microcrystalline wax, vegetable fats, animal fats, ester waxes, fatty acid esters, and alkali and alkaline earth metal and ammonium salts of fatty acids, hydroxypolyesters and combinations and mixtures thereof.

Optionally, the carrier composition may include an emollient. Examples of appropriate emollients include lanolin oil and its derivatives, mineral oil, fatty esters, fatty acid esters, fatty alcohols, mono- and di-esters of propylene glycols, glycerol di-esters, mono- and di-esters of poly ethylene glycols, petrolatum, vegetable shortening, dimers and trimers of fatty acids, plant oils, silicones and combinations and mixtures thereof.

In one aspect, the chromogenic material may be a colorless dye that may react with the developer composition on the substrate and become colored. For example, the chromogenic material may be leuco in nature and may be rendered colored upon contact with an acidic developer composition.

Examples of appropriate chromogenic materials include substantially colorless compounds such as triarylmethane compounds, biphenylmethane compounds, xanthene compounds, thiazine compounds, spiropyran compounds and the like. The compounds may have in their partial skeleton a lactone, a lactam, a sultone, a spiropyran, an ester or an amido structure. More specifically, such compounds may include crystal violet lactone, benzoyl leuco methylene blue, Malachite Green Lactone, p-nitrobenzoyl leuco methylene blue, 3-dialkylamino-7-dialkylamino-fluoran, 3-methyl-2,2′-spirobi(benzo-f-chrome), 3,3-bis(p-dimethylaminophenyl)phthalide, 3-(p-dimethylaminophenyl)-3-(1,2-dimethylindole-3-yl)phthalide, 3-(p-dimethylaminophenyl)-3-(2-methylindole-3-yl)phthalide, 3-(p-dimethylaminophenyl)-3-(2-phenylindole-3-yl)phthalide, 3,3-bis(1,2-dimethylindole-3-yl)-5-dimethylaminophthalide, 3,3-bis-(1,2-dimethylindole-3-yl)-6-dimethylaminophthalide, 3,3-bis-(9-ethylcarbazole-3-yl)-5-dimethylaminophthalide, 3,3-bis(2-phenylindole-3-yl)-5-dimethylaminophthalide, 3-p-dimethylaminophenyl-3-(1-methylpyrrole-2-yl)-6-dimethylaminophthalide, 4,4′-bis-dimethylaminobenzhydrin benzyl ether, N-halophenyl leuco Auramine, N-2,4,5-trichlorophenyl leuco Auramine, Rhodamine-B-anilinolactam, Thodamine-(p-nitroanilino)lactam, Rhodamine-B-(p-chloroanilino)lactam, 3-dimethylamino-6-methoxyfluoran, 3-diethylamino-7-methoxyfluoran, 3-diethylamino-7-chloro-6-methylfluoran, 3-diethylamino-6-methyl-7-anilinofluoran, 3-diethylamino-7-(acetylmethylamino)fluoran, 3-diethylamino-7-(dibenzylamino)fluoran, 3-diethylamino-7-(methylbenzylamino)fluoran, 3-diethylamino-7-(chloroethylmethylamino)fluoran, 3-diethylamino-7-(diethylamino)fluoran, 3-methyl-spiro-dinaphthopyran, 3,3′-dichloro-spiro-dinaphthopyran, 3-benzyl-spiro-dinaphthopyran, 3-methyl-naphtho-(3-methoxybenzo)-spiropyran, 3-propyl-spirodibenzoidipyran and combination and mixtures thereof.

In another aspect, the chromogenic material may be a fluoran compound of the type disclosed in U.S. Pat. No. 3,920,510, the entire contents of which are incorporated herein by reference.

In yet another aspect, the chromogenic material may be an organic compound capable of reacting with heavy metal salts to give colored metal complexes, chelates or salts.

### EXAMPLES

A first exemplary ink component of the disclosed ink and developer system may be prepared as a mixture including 0.5 percent by weight red dye and 99.5 percent by weight soya oil. The red dye may be 3,3-bis(1-n-butyl-2-methyl-3-indolyl) phthalide (CAS # 50292-91-6, ENCS # 5-6143) and the soya oil may be comprised of fatty acid methyl esters (CAS # 67784-80-9).

A second exemplary ink component of the disclosed ink and developer system may be prepared as a mixture including 0.5 percent by weight blue dye and 99.5 percent by weight soya oil. The blue dye may be 3-(4-Diethylamino-2-ethoxyphenyl)-3-(1-ethyl-2-methyl-3-indolyl)-4-azaphthalide (CAS # 69898-40-4, ENCS # 5-5382) and the soya oil may be comprised of fatty acid methyl esters (CAS # 67784-80-9).

A third exemplary ink component of the disclosed ink and developer system may be prepared as a mixture including 0.5 percent by weight green dye and 99.5 percent by weight soya oil. The green dye may be 3,6,6′-Tris (Dimethyl amino)Spiro[fluoren-9,3′-phthalide (CAS # 85391-59-9, ENCS # 5-5815) and the soya oil may be comprised of fatty acid methyl esters (CAS # 67784-80-9).

An exemplary substrate of the disclosed ink and developer system may be prepared by coating a base substrate with a resin coating. The base substrate may be a C1S or C2S paperboard substrate having a thickness of about 2.5 mil to about 3.2 mil. The resin coating may be a single layer of resin dispersion, with a dry coat weight of about 14 to about 15 pounds per ream. The resin dispersion may be comprised of dicarboxylic acid resin dispersion (23.71 weight percent), calcium carbonate slurry (23.71 weight percent), binders (10.43 weight percent total) and water (42.15 weight percent) (CAS # 7732-18-5). The bulk concentration of the resin dispersion may be about 33 weight percent zinc, bis{2-hydroxy-3,5-bis(1-phenylethyl-benzoate (CAS # 53770-52-8, TSCA 68083-98-7). The bulk concentration of the calcium carbonate slurry may be about 76 weight percent calcium carbonate (CAS # 1317-65-3). The bulk concentration of binders may be about 60 weight percent vinyl acetate/ethylene copolymer and about 10 weight percent polyvinyl acetate (PVA).

The first, second and third exemplary ink components may be generally colorless and may be rendered colored (red, blue and green, respectively) upon application of the ink components to the exemplary substrate.

Although various aspects of the disclosed ink and developer system have been shown and described, modifications may occur to those skilled in the art upon reading the specification. The present application includes such modifications and is limited only by the scope of the claims.

What is claimed is:

1. An ink and developer system comprising:
an ink component including a non-synthetic oil-based carrier and a chromogenic material dispersed or dissolved in said non-synthetic oil-based carrier; and
a substrate including a developer composition capable of initiating a color change in said chromogenic material.

2. The system of claim 1 wherein said ink component is generally colorless prior to contact with said developer composition.

3. The system of claim 1 wherein said non-synthetic oil-based carrier is a plant-derived oil.

4. The system of claim 1 wherein said non-synthetic oil-based carrier includes at least one of a vegetable oil, a canola oil, a corn oil, a soya oil, a sunflower seed oil, a peanut oil and an olive oil.

5. The system of claim 1 wherein said non-synthetic oil-based carrier is food grade.

6. The system of claim 1 wherein said non-synthetic oil-based carrier includes an emollient.

7. The system of claim 1 wherein said chromogenic material is a colorless dye.

8. The system of claim 1 wherein said chromogenic material is a colorless leuco dye.

9. The system of claim 1 wherein said chromogenic material is selected from the group consisting of crystal violet lactone, benzoyl leuco methylene blue, Malachite Green Lactone, p-nitrobenzoyl leuco methylene blue, 3-dialkylamino-7-dialkylamino-fluoran, 3-methyl-2,2′-spirobi(benzo-f-chrome), 3,3-bis(p-dimethylaminophenyl)phthalide, 3-(p-dimethylaminophenyl)-3-(1,2-dimethylindole-3-yl)phthalide, 3-(p-dimethylaminophenyl)-3-(2-methylindole-3-yl)phthalide, 3-(p-dimethylaminophenyl)-3-(2-phenylindole-3-yl)phthalide, 3,3-bis(1,2-dimethylindole-3-yl)-5-dimethylaminophthalide, 3,3-bis-(1,2-dimethylindole-3-yl)-6-dimethylaminophthalide, 3,3-bis-(9-ethylcarbazole-3-yl)-5-dimethylaminophthalide, 3,3-bis(2 phenylindole-3-yl)-5-dimethylaminophthalide, 3-p-dimethylaminophenyl-3-(1-methylpyrrole-2-yl)-6-dimethylaminophthalide, 4,4′-bis-dimethylaminobenzhydrin benzyl ether, N-halophenyl leuco Auramine, N-2,4,5-trichlorophenyl leuco Auramine, Rhodamine-B-anilinolactam, Thodamine-(p-nitroanilino)lactam, Rhodamine-B-(p-chloroanilino)lactam, 3-dimethylamino-6-methoxyfluoran, 3-diethylamino-7-methoxyfluoran, 3-diethylamino-7-chloro-6-methylfluoran, 3-diethylamino-6-methyl-7-anilinofluoran, 3-diethylamino-7-(acetylmethylamino)fluoran, 3-diethylamino-7-(dibenzylamino)fluoran, 3-diethylamino-7-(methylbenzylamino)fluoran, 3-diethylamino-7-(chloroethylmethylamino)fluoran, 3-diethylamino-7-(diethylamino)fluoran, 3-methyl-spiro-dinaphthopyran, 3,3′-dichloro-spiro-dinaphthopyran, 3-benzyl-spiro-dinaphthopyran, 3-methyl-naphtho-(3-methoxybenzo)-spiropyran, 3-propyl-spirodibenzoidipyran and combinations thereof.

10. The system of claim 1 wherein said substrate includes at least one of a paper-based material and a polymeric material.

11. The system of claim 1 wherein said substrate is a part of a school or office product.

12. The system of claim 1 wherein said developer composition is coated onto said substrate.

13. The system of claim 1 wherein said developer composition includes an organic acid.

14. The system of claim 1 wherein said developer composition includes an acid resin.

15. The system of claim 1 wherein said ink component is physically compatible with said substrate.

16. The system of claim 1 wherein said chromogenic material undergoes said color change upon contact with said developer composition.

17. A kit comprising said ink component and said substrate of claim 1.

18. The kit of claim 17 wherein said ink component is packaged in a vessel.

19. An ink and developer system comprising:
an ink component including a plant-derived oil carrier and a leuco dye dispersed or dissolved in said plant-derived oil carrier; and
a substrate including an acid resin capable of initiating a color change in said leuco dye.

20. A method for creating a colored marking comprising the steps of:
providing a substrate including a developer composition;
applying an ink composition onto said substrate, said ink composition including a non-synthetic oil-based carrier and a chromogenic material dispersed or dissolved in said non-synthetic oil-based carrier,
wherein said chromogenic material undergoes a color change upon contact with said developer composition.
